(19) United States
(12) Patent Application Publication
(10) Pub. No.: US 2026/0287063 A1
(43) Pub. Date: Sep. 24, 2026

(54) PUSHER SEAL ASSEMBLY

(71) Applicant: JOHN CRANE INC., Morton Grove, IL (US)

(72) Inventors: Robert F. McManus, Portsmouth, RI (US); Denis Rainville, Glocester, RI (US); Jamie Maccarone, Warwick, RI (US)

(73) Assignee: JOHN CRANE INC., Morton Grove, IL (US)

(21) Appl. No.: 19/559,359

(22) Filed: Mar. 6, 2026

Related U.S. Application Data
(60) Provisional application No. 63/775,097, filed on Mar. 20, 2025.

(51) Int. Cl. F16J 15/54

(52) U.S. Cl. CPC F16J 15/54

(57) ABSTRACT

Aspects include a pusher seal assembly for a mechanical seal providing a seal around a rotating shaft. A pusher seal assembly includes: an axially movable first seal ring configured to be disposed annularly about the shaft, the first seal ring comprising a first seal face for providing a seal interface with a second seal face of a second seal ring; a biasing mechanism configured to provide an axial biasing force on the first seal ring orthogonal to the first seal face; a secondary seal configured to provide a seal against a surface along which the first seal ring is axially movable. The secondary seal comprises a graphite seal ring. The pusher seal assembly is configured to allow axial pressure to be applied to the graphite seal ring separately from the biasing mechanism, to cause radial expansion of the graphite seal ring.

### CROSS-REFERENCE TO RELATED APPLICATION(S)

This application claims the benefit of priority under 35 U.S.C. § 119(e) to U.S. Provisional Patent Application Ser. No. 63/775,097, filed Mar. 20, 2025. The entire content of each application is hereby incorporated by reference herein.

The present disclosure relates to a mechanical seal and more particularly to a pusher seal assembly within a mechanical seal system, and methods of installing a pusher seal assembly.

### BACKGROUND

Mechanical seals are commonly used in rotating equipment, such as compressors, turbines and pumps. In these systems, the mechanical seals are used to seal a rotating shaft to a stationary housing without loss of large volumes of pressurised fluid.

Mechanical seals contain a primary seal that seals the rotating shaft and the stationary housing together. These primary seals have two components, typically seal rings, with sealing faces and the sealing faces rotate relative to each other. This is achieved by coupling one of the sealing faces of the primary seal to the rotating shaft and coupling the other with the stationary housing. As such, one sealing face will rotate with the rotating shaft against a stationary sealing face. The seal rings can be sealed against the rotating shaft or the stationary housing respectively using a secondary sealing element to prevent fluids bypassing the primary seal. As will be appreciated, where a secondary seal seals against the shaft or the stationary housing, this is typically indirect in the sense that a sleeve or similar component will typically separate the secondary seal from the physical shaft or stationary housing, but where the sleeve is fixed to and rotates with the shaft or is stationary if fixed to the stationary housing.

Mechanical seals can be categorised into pusher seals and non-pusher seals. Such seals provide a primary seal that allows axial movement of seal rings to maintain a closed seal interface, for example when axial shaft movement may move the seal rings of the primary seal apart and can account for wear of the seal faces. Pusher seals are one of the most common types of mechanical seals. They are prevalent in many industries, such as chemical, petrochemical, refining, paper production, grain processing as examples.

In non-pusher seals, a secondary seal is typically made up of a bellows assembly that prevents the passage of gas around the primary seal as well as providing an axial biasing force and axial flexibility to maintain pressure between the seal rings of the primary seal. As the bellows prevents the passage of fluids around the primary seal interface, there is no need for a secondary seal to seal the connected seal ring of the primary seal against the surface along which it moves axially.

On the other hand, in pusher seals, this is typically achieved by providing a biasing element, such as a spring, instead of a bellows assembly, which does not itself prevent the passage of fluids around the primary seal. Therefore, a secondary seal acts as a dynamic seal to prevent the passage of fluids around the primary seal interface, and must be designed such that the secondary seal can provide an axially movable seal against a surface along which the respective seal ring of the primary seal moves. This allows the seal to allow for continued wear of the primary seal faces during use or small movements that may occur between the rotating shaft and the stationary housing, such as vibrations. Otherwise, shaft movement may cause damage to the primary seal faces or significant leakage where the seal cannot close sufficiently.

The dynamic secondary sealing element in a pusher seal is typically an O-ring or wedge. These secondary sealing elements are typically O-rings or wedges made from elastomeric compounds or PTFE. These materials allow for deformation of the ring or wedge under pressure to provide an effective seal as a result of elastomeric materials being able to maintain a sealing force by compression in a restricted space. Typically, grooves are present in the pusher seal system, which provide enough pressure to the elastomeric O-ring or wedge to ensure that the element provides a seal, even whilst there is no hydraulic pressure being applied to the seal. Additionally, O-rings or wedges can be self-sealing when sealing to the rotating shaft due to the inner diameter being slightly smaller or larger that the diameter of the surface around which they seal, such that they provide a constant pressure radially against the surface. As the materials are elastomeric, they can be deformed to mount the seal in place, and once in place the elastic nature of the material following deformation provides a sealing force.

It is often important for the secondary seal to have a level of chemical resistance to avoid degradation of the seal. PFAS (per-fluoroalkyl substances) materials such as PTFE are often used in the manufacture of these secondary seals in order to provide these properties. However, there is growing concern that PFAS materials are harmful to the environment or heath and thus makes their use undesirable. Additionally, there is increasing legislation attempting to eliminate the use of PFAS materials. While non-PFAS based O-rings can provide suitable mechanical properties, they are often susceptible to chemical degradation by swelling, loss of material and/or changes in mechanical properties.

Accordingly, there is a need for pusher seal assembly containing secondary seal rings that provide desirable mechanical and chemical properties, whilst still allowing for the movement required by the secondary sealing element in a pusher seal assembly.

### SUMMARY

The present disclosure is directed to a pusher seal assembly for a mechanical seal providing a seal around a rotating shaft. According to a first aspect there is provided a pusher seal assembly, the pusher seal assembly comprising:
an axially movable first seal ring configured to be disposed annularly about the shaft, the first seal ring comprising a first seal face for providing a seal interface with a second seal face of a second seal ring;
a biasing mechanism configured to provide an axial biasing force on the first seal ring orthogonal to the first seal face;
a secondary seal configured to provide a seal against a surface along which the first seal ring is axially movable, wherein the secondary seal comprises a graphite seal ring; and
the pusher seal assembly is configured to allow axial pressure to be applied to the graphite seal ring separately from the biasing mechanism, to cause radial expansion of the graphite seal ring.

The pusher seal assembly provides a pusher seal assembly wherein the secondary seal provides improved thermal and/or chemical resistance compared to traditional elastomeric components. Graphite seal rings can provide corrosion resistance and can provide good performance across a broad range of temperatures and pressures. Additionally, the use of PFAS materials may be avoided.

The pusher seal assembly of the present disclosure allows for axial pressure to be applied to the graphite seal ring. The terms axial and axially are used to describe the direction longitudinally along the rotating shaft (parallel to its axis of rotation). The terms radial and radially are used to describe the planes generally perpendicular to the axis of rotation of the shaft.

The applied axial pressure causes radial expansion of the graphite seal ring. This radial expansion allows for the graphite seal ring to provide a seal against a surface against which the first seal ring moves axially. As will be appreciated, the axial pressure may suitably be applied such that axial movement of the graphite secondary seal ring is possible without significant disruption of the radial sealing effect. Typically, graphite seal rings are used in static seals where the graphite seal ring is compressed to provide the desired seal, for example by compression of the seal between components between which a seal is required. However, where a dynamic (i.e. movable) seal is required, compression of components together to form the seal is not generally possible because binding components together to cause compression also prevents relative movement of these components. By providing a seal assembly in which axial pressure can be applied to a graphite seal ring of secondary seal separately from a biasing mechanism, the graphite seal ring can be radially expanded to provide a radial seal. As the initial deformation of graphite seal rings is at least partially permanent (inelastic) deformation, it is not subsequently necessary to maintain axial pressure on the graphite seal ring beyond that provided by the biasing mechanism and any hydraulic pressure across the seal. As graphite seal rings cannot be stretched and compressed elastically in the way that elastomeric seal rings can, the configuration of the present pusher seal also allows installation of the seal assembly around a shaft without requiring stretching or compression of the secondary seal during installation, as radial expansion can be applied following installation. For example, typical elastomeric secondary seal rings are stretched or compressed during installation around a shaft so that following installation there is an inherent radial sealing force due to the elastic properties of the material. The present push seal assembly allows for the use of graphite secondary seal rings by permitting axial force to be applied to a graphite seal ring after installation around a shaft, to cause radial expansion of the graphite seal ring to provide the secondary seal.

The pusher seal assembly is configured such that the radial expansion seals the graphite seal ring against a surface along which the first seal ring is axially movable. This may be, for example, the rotating shaft or the stationary housing that surrounds the rotating shaft (i.e. a housing of the rotating apparatus being sealed). When coupling the first seal ring with the rotating shaft, the graphite seal ring may be sealed against a shaft sleeve that is fixed to the rotating shaft. Accordingly, as can be readily envisaged, the first seal ring of the pusher seal assembly may be coupled to the rotating shaft and therefore be a rotating seal ring. Alternatively, the first seal ring may be coupled to the stationary housing and be rotationally stationary. Thus, the graphite seal ring may provide a seal at its outer diameter against a stationary surface, or may provide a seal at its inner diameter against a surface, for example of a shaft sleeve, that is coupled to and rotates with the rotating shaft.

The first seal ring may be a typical mechanical seal system seal ring and it will be appreciated that such seals are known in the art. For example, the seal face may be formed from silicon carbide or any other suitable material. Additionally, the seal face of the first seal ring and/or the second seal ring may have channels which help maintain a small gap between the seal faces to prevent excessive wear. These channels allow for introducing fluid between the seal gap causing hydrostatic lift between the two faces. For example, the seal may be a non-contacting gas seal. However, the nature of the seal faces is not particularly limited and any suitable seal ring configuration may be used.

The biasing mechanism axially biases the first seal ring. The biasing mechanism is suitably configured to urge the first seal ring towards a second seal ring, to form a seal interface (i.e. a rotating seal interface) between the first and second seal rings. The biasing mechanism is configured to move the dynamic graphite secondary seal ring and first seal ring axially along the shaft or sleeve. This ensures that movements in the system, such as any vibrations of the rotating shaft and or stationary housing, do not result in damage to the seal faces occurring from collisions or leakage due to gaps between the seal faces. Instead, axial movement of the rotating shaft in relation to the stationary housing will be compensated for by the biasing mechanism.

The biasing mechanism may include any suitable biasing means configured to maintain a sealing interface between a first seal ring and a second seal ring. For example, the biasing mechanism may include a spring, for example a series of springs, for example the biasing mechanism may comprise a single coil spring, multiple coil springs, a wave spring, or a Belleville washer. When the sealing gap between the sealing faces of a first and second seal ring becomes either too large or too small, the first seal ring will move and the springs will elastically deform to maintain the seal interface, with the secondary seal ring moving with the first seal ring to maintain the secondary seal in response to axial movement of the shaft relative to the stationary housing. In this manner, the biasing mechanism ensures that a consistent seal is achieved.

The biasing mechanism may in part provide the axial pressure on the graphite seal ring. For example, the graphite seal ring may be arranged between the biasing mechanism and the first seal ring. This added axial pressure provided by the biasing mechanism may help maintain a consistent seal formed by the graphite seal by providing sustained pressure during operation of the seal. Thus, the axial pressure applied to the graphite seal ring may suitably be the total of the axial pressure applied by the biasing mechanism, and the axial pressure applied separately from the biasing mechanism (for example by a loading structure as defined herein).

The pusher seal assembly is configured to allow axial pressure to be applied to the graphite seal ring separately from the biasing mechanism to cause radial expansion of the graphite seal ring. It will be appreciated that the exact pressure applied will vary depending on the scale/size of the seal and the materials used, as well as the extent to which the biasing mechanism separately applies axial pressure to the graphite seal ring. This radial expansion may be caused by non-elastic or elastic deformation of the graphite seal ring. Typically, the graphite seal ring is non-elastically deformed by the axial pressure to form the secondary seal. The pusher seal assembly may be configured to apply axial pressure to non-elastically “crush” the graphite seal ring into a sealing configuration, where a seal is maintained by the deformation of the graphite seal ring, wherein the axial pressure may be released prior to operation of the system. For example, the pusher seal assembly is preferably configured to allow axial pressure to be applied to the graphite seal ring separately from the biasing mechanism to cause radial expansion of the graphite seal ring, wherein the pusher seal assembly is configured to allow the axial pressure to be reduced or released prior to operation of the system (i.e. operation of the apparatus to be sealed by the pusher seal). Alternatively, the axial pressure is provided throughout operation of the pusher seal assembly to maintain the graphite ring in a sealing configuration.

In preferred embodiments, the axial pressure is applied prior to operation of the system, and therefore the graphite seal ring is sealed to the rotating shaft or stationary housing prior to any fluid flow, and when there is no hydraulic pressure exerted on the seal by the system. For example, the axial pressure is preferably applied during installation of the pusher seal assembly around a shaft. The seal between the graphite seal ring and the shaft/housing may be maintained during operation of the system due to non-elastic deformation of the graphite seal ring. It will be appreciated that the hydraulic forces present during operation can apply additional axial pressure to the seal and to the graphite sealing ring.

The biasing mechanism is typically not sufficient to provide enough axial pressure to the graphite seal ring to provide a sealing configuration. This is because the graphite seal ring is relatively inflexible and inelastic compared with known elastomeric dynamic secondary rings. As such, a greater amount of axial pressure is required than is generally provided by a biasing mechanism of a pusher seal in order to provide the secondary seal, for example to cause non-elastic deformation (radial expansion) of the graphite seal ring. Axial force can be applied to the graphite seal ring separately from the biasing mechanism to cause radial expansion of the graphite seal ring. The axial force is configured to be applied separately from the biasing mechanism in the sense that the axial pressure may be increased above the pressure provided by the biasing mechanism alone, for example above the pressure applied by the biasing mechanism during operation of the seal when the shaft is rotating. However, in some embodiments the additional axial pressure may nonetheless be applied via the biasing mechanism, for example by applying pressure to the biasing mechanism to increase (and subsequently restore) the force provided the biasing mechanism, for example by tightening or compressing one or more springs of the biasing mechanism. Preferably, the axial pressure applied to the graphite seal ring separately from the biasing mechanism is separate from the biasing mechanism in the sense that at least a portion, preferably all, of the additional axial force is not applied to the graphite seal ring is not applied via the basing mechanism. For example, axial pressure may be applied to the graphite seal ring independently of the biasing mechanism, for example wherein the axial force applied by the biasing mechanism remains constant or reduces during application of axial pressure to cause radial expansion of the graphite seal ring.

The graphite seal ring may preferably be a flexible graphite seal ring, and such materials are known in the art. For example, the graphite seal ring may be formed from a flexible graphite ribbon material and the manufacture of graphite seal rings is known in the art. For example, exfoliated or expanded graphite may be formed into die-compressed rings. The graphite seal ring may suitably provide, for example, a resultant radial reaction load of approximately 60% of an applied axial load. The graphite seal ring may be formed into different shapes or designs. The graphite seal ring may comprise a circular cross section, elliptical cross section, square cross section, rectangular cross section or a hexagonal cross section. In preferred embodiments, the graphite seal ring comprises a die formed flexible graphite ring.

Preferably, the secondary seal is substantially PFAS free. For example, the secondary seal may consist of one or more graphite seal rings as described herein. Thus, the secondary seal of the pusher seal assembly preferably comprises no PFAS-based materials.

Any suitable configuration may be used to apply axial pressure to the graphite seal ring to cause radial expansion of the graphite seal ring and form a seal, for example to cause inelastic radial expansion of the graphite seal ring. In preferred embodiments, the pusher seal assembly further comprises a loading structure for applying axial pressure to the graphite seal ring. For example, the loading structure may be operable to apply adjustable axial pressure to the graphite seal ring. It is not necessary that the loading structure is configured to apply axial pressure to the graphite seal ring constantly during operation of the pusher seal system. Preferably, the loading structure is configured to apply axial pressure to the graphite seal ring to cause inelastic radial expansion of the graphite seal ring, wherein the axial pressure may be released following inelastic expansion of the graphite seal ring.

The provision of adjustable axial pressure can allow a user to optimise the amount of pressure applied to the graphite ring depending on the system's requirements. For example, the system may require that different amounts of axial pressure be applied to the graphite ring depending on the hydraulic pressures that are present in a given system. Additionally, a clearance gap between the graphite ring and the surface to which it is sealed may determine the level of axial pressure required to provide sufficient radial expansion of the graphite ring, and adjustable application of pressure can allow the seal to account for variation in dimensions of components of the seal, for example due to manufacturing tolerances.

Preferably, the loading structure comprises an axially fixed collar or sleeve configured to engage one or more axially movable loading members. For example, the axially movable loading members are suitably configured to engage the loading structure and the graphite seal ring, so that axial movement of the loading members relative to the loading structure can apply axial pressure to the graphite seal ring. It will be appreciated that the axially movable loading members may engage indirectly with the loading structure and/or with the graphite seal ring. For example, the loading members may contact the graphite seal ring but preferably are not in direct contact with the graphite seal ring. Preferably, the loading members are separated from the graphite seal ring by one or more components configured to distribute pressure from the loading members around the circumference of the graphite seal ring. Preferably, the one or more loading members comprise one or more screws, however any suitable axially movable loading members may be used. For example, the axially fixed collar or sleeve may contain one or more threaded holes through which one or more screws may pass. The screws can then be tightened to allow variable axial pressure to be applied to the graphite seal ring. As will be appreciated, the axially fixed collar may be fixed to the shaft or the stationary side of the seal (e.g. a housing of the rotating apparatus being sealed) depending on where the pusher seal is installed. It will be appreciated that the axially fixed collar is “axially fixed” in the sense that it is axially fixed when installed in a mechanical seal, but when not installed in a mechanical seal the axially fixed collar is axially fixable within a rotating mechanical seal.

The loading members, such as the screws, may be arranged such that the loading members are in indirect contact with the graphite seal ring when engaged. For example, the loading members are separated from the graphite seal ring by one or more components configured to distribute pressure from the loading members around the circumference of the graphite seal ring. For example, one or more annular rings may be arranged between the loading members and the graphite seal ring to distribute pressure from the loading members around the circumference of the graphite seal ring.

In preferred embodiments, the secondary seal of the present disclosure comprises a compression ring arranged to engage the graphite seal ring. The compression ring is preferably arranged so that the graphite seal ring is disposed between the compression ring and the first seal ring, for example so that the axial pressure is applied to the compression ring and thereby applied to the graphite seal ring. Thus, the graphite seal ring may be arranged between the compression ring and the first seal ring. For example, the compression ring is preferably arranged between the loading mechanism described previously and the graphite seal ring, for example between one or more loading members and the graphite seal ring. The compression ring may suitably be in direct contact with the graphite seal ring.

Preferably, the compression ring and/or the first seal ring comprise an annular groove and the graphite seal ring is be arranged within the annular groove. For example, the graphite seal ring may protrude axially from the annular groove to allow axial compression of the graphite seal ring. For example, the compression ring may comprise an annular groove having an axial length smaller than the axial length of the graphite seal ring. In this way, when axial pressure is applied via the compression ring to the graphite seal ring, the graphite seal ring is compressed against the first seal ring. Where the first seal ring comprises an annular groove for receiving the graphite seal ring, the annular groove may similarly have an axial length smaller than the axial length of the graphite seal ring. In embodiments where the first seal ring comprises an annular groove, it will be appreciated that the compression ring may not be required. However, the use of a compression ring allows for this component to me designed for the specific purpose of engaging the graphite seal ring and can avoid the need for a specifically designed first seal ring, increasing efficiency and ease of manufacture of the seal, as existing seal rings may be used for the first seal ring, which may be advantageous if the first seal ring requires replacement, due to wear on the rotating seal rings, for example. In some embodiments, the compression ring and the first seal ring have annular grooves arranged such that the graphite seal ring is disposed in a gap (defined by the annular grooves) between the compression ring and the back of the first seal ring. For example, both the compression ring and the first seal ring may comprise first and second annular grooves, respectively, configured to receive the graphite seal ring, wherein the combined axial length of the first and second annular grooves is less than the axial length of the graphite seal ring. In some embodiments, the annular groove of the compression ring or the first seal ring may have a larger axial length than the axial length of the seal ring, in which case the other of the compression ring or the first seal ring (not having an annular groove for receiving the graphite seal ring) may comprise an annular projection extending axially and configured to extend into the annular groove to allow compression of the graphite seal ring within the annular groove. In some embodiments, the compression ring or the first seal ring may comprise a secondary annular groove configured to receive an axially extending projection of the other of the compression ring or the first seal ring, which may improve stability and rigidity of the seal.

The presence of a compression ring may allow for easier assembly of the pusher seal assembly and/or a pre-assembled pusher seal cartridge, for example by aiding handling and arrangement of the graphite seal ring within the pusher seal. Additionally, the presence of a compression ring can reduce the potential for damage to the graphite seal ring, for example during installation and operation. The compression ring may allow the user to control the directionality of the radial expansion of the graphite seal ring. When axial pressure is applied to the graphite seal ring, the graphite expands radially outward. Accordingly, the compression ring may suitably be configured to force the graphite seal ring to expand towards the sealing surface, such as the rotating shaft (or a sleeve fixed to the rotating shaft) or the housing that surrounds the rotating shaft. For example, the compression ring may comprise an annular groove (for example an annular groove as described previously) at the inner diameter or the outer diameter of the compression ring that the graphite seal ring sits within (depending on whether the pusher seal is attached and rotationally stationary relative to the shaft or the housing). The annular groove may provide an axially extending surface abutting the graphite seal ring, which limits radial expansion, forcing the graphite seal ring to expand away from the axially extending surface of the annular groove, towards the axially extending surface along which the graphite seal ring moves. Thus, where the pusher seal is configured to rotate with the shaft (i.e. when it is coupled to the shaft), the compression ring can provide an annular groove having an axially extending surface abutting the graphite seal ring at its outer diameter. Similarly, where the pusher seal is configured to be rotationally stationary relative to the shaft (i.e. when it is coupled to the housing), the compression ring can provide an annular groove having an axially extending surface abutting the graphite seal ring at its inner diameter.

The compression ring may be formed from any suitable material, and it will be appreciated that the compression ring is preferably PFAS free and formed of a non-elastic material. Suitable materials for the compression ring include, for example, silicon carbide, stainless steel alloys, nickel alloys or combinations thereof. Particularly preferable stainless steel alloys include UNS S31600. Particularly preferable nickel alloys include INCOLOY® Alloy 20, INCONEL® alloy C276 or MONEL® alloys.

Alternatively, as described, the pusher seal may be arranged to not require a compression ring. For example, the graphite secondary seal may be positioned within an annular groove of the first seal ring disposed on the side axially opposite to the seal face that forms the seal interface of the rotating seal.

The pusher seal may comprise one or more annular rings configured to distribute axial pressure around the circumference of the graphite seal ring, for example the axial pressure provided by a loading structure comprising one or more loading members as described herein. As will be appreciated, such annular rings may also be configured to distribute the pressure applied by the biasing mechanism around the circumference of the pusher seal. For example, in preferred embodiments, the pusher seal assembly further comprises an annular bearing, such as a thrust washer. The annular bearing may be arranged to circumferentially distribute axial forces applied to the first seal ring. This may be achieved by arranging the graphite seal ring between the annular bearing and the first seal ring, preferably wherein a compression ring as described herein separates the annular bearing from the graphite seal ring. For example, the pusher seal may comprise an annular bearing separating the biasing mechanism and/or the loading structure (such as the one or more loading members) from a compression ring, and the graphite seal ring disposed between the compression ring and the first seal ring.

The pusher seal assembly may comprise a pusher seal housing having an axially inboard wall and axially outboard wall. As will be appreciated, axially inboard refers to the direction (and side of the seal) towards the interior of the chamber being sealed by the rotating mechanical seal, while outboard refers to the direction (and side of the seal) towards the exterior of the chamber being sealed (e.g. to atmosphere). Thus, the axially inboard wall and axially outboard wall suitably comprise radially extending surfaces. It will also be appreciated that the pusher seal may suitably be arranged axially inboard or axially outboard of the seal interface, and so “inboard” and “outboard” may be exchanged depending on the orientation that the pusher seal is installed in a system to be sealed. The axially inboard wall and the axially outboard wall of the pusher seal housing may suitably be arranged to face each other. Preferably, the biasing mechanism and the first seal ring are axially disposed between the axially inboard wall and axially outboard wall. The loading structure may be operable to compress the graphite seal ring and the first seal ring axially between the axially inboard wall and the axially outboard wall of the pusher seal housing. The pusher seal housing may suitably comprise a retaining ring having an axially inboard wall and axially outboard wall configured to contain the pusher seal assembly, wherein the axially inboard wall and axially outboard wall extend radially and an axially extending wall joins the axially inboard wall with the axially outboard wall.

Accordingly, the pusher seal housing may suitably assist the loading structure, for example, the pusher seal housing may provide a surface against which the components of the seal can be compressed to apply axial pressure to the graphite seal ring. For example, the first seal ring may abut one of the axially inboard or axially outboard walls of the pusher seal housing to limit axial movement of the first seal ring, so that axial force applied to the graphite seal ring compresses the graphite seal ring axially against the first seal ring and compresses the first seal ring between the graphite seal ring and the wall of the pusher seal housing against which it abuts.

In preferred embodiments, the loading structure comprises an axially fixed collar with one or more threaded holes that are configured to engage one or more screws that can be tightened to compress the graphite seal ring. The axially inboard or outboard wall of the pusher seal housing may abut the axially fixed collar, where the graphite seal ring and the first seal ring are arranged between the axially inboard and outboard walls of the pusher seal housing so that the first seal ring abuts the other of the axially inboard or outboard wall of the pusher seal housing. Preferably, the pusher seal housing limits axial movement of the first seal ring relative to the axially fixed collar, so that the graphite seal ring can be compressed against the first seal ring. This permits axial pressure to be conveniently applied to the graphite seal ring during installation of the seal, where the first seal ring may not axially engage any other component at its seal face (i.e. when the second seal ring is not present). The axially fixed collar may be located at an inboard wall of the pusher seal housing and the first seal ring at an axially outboard wall of the pusher seal housing, or vice versa.

In preferred embodiments, the pusher seal housing is removable from the pusher seal assembly when the pusher seal is installed around the shaft. For example, the pusher seal housing may be configured such that the pusher seal housing may be removed following installation of the pusher seal around the shaft. The pusher seal housing may comprise grooves or cut-outs that allow for the loading members, for example screws, to be engaged whilst the pusher seal housing is in place, for example wherein the grooves or cut-outs (in the inboard or outboard wall) allow for screws to be tightened. Preferably, the pusher seal housing comprises a split ring retainer. Typically, a split ring retain comprises two halves that generally surround the pusher seal when the housing is in place, but such that each half of the split ring retainer can be removed without requiring disassembly or movement of the pusher seal. A split ring retainer may therefore be readily installed and removed from the pusher seal assembly, for example wherein the split ring retainer is in place to permit axial compression to be applied to the graphite seal ring to provide the secondary seal, following which the split ring retainer may be removed prior to normal operation of the rotating seal system. The split ring retainer may be fixed to the pusher seal system for stability in any suitable way, for example by one or more screws extending radially inward from the pusher seal housing to engage with the axially fixed collar.

According to a second aspect, there is provided a mechanical seal system for providing a seal around a rotating shaft, the mechanical seal comprising:
a pusher seal assembly as defined herein and a second seal ring comprising a second seal face configured to oppose the first seal face to provide a seal interface therebetween;
the biasing mechanism configured to provide an axial biasing force on the first seal ring towards the second seal ring.

The first seal ring of the present disclosure may be a primary ring of a mechanical seal system and the second seal ring may be a mating ring. Together, the primary ring and the mating ring may form a seal interface that seals a rotating shaft to a stationary housing. The primary ring may either rotate with the rotating shaft or be coupled to the stationary housing and rotationally fixed.

The second seal ring may be a typical mechanical seal system seal ring. For example, the seal face may be formed from silicon carbide or any other suitable material. Additionally, the seal faces of the first seal ring and/or the second seal ring may comprise channels which help to maintain a gap between the seal faces during operation to prevent excessive wear. These channels can pump gas between the seal faces during rotation of the seal to cause hydrostatic lift between the two faces and maintain a gap at the seal interface. Thus, the mechanical seal may be a non-contacting mechanical seal configured to seal a gas. In other embodiments, the mechanical seal may be a contacting seal in which the seal faces may be suitably lubricated to enable rotation without excessive wear, for example the mechanical seal may be configured to seal a liquid. It will be appreciated that such seals are known in the art.

It will be appreciated that the mechanical seal may comprise further components used to couple the seal with the stationary housing and/or the rotating shaft. It will also be appreciated that the components and arrangement of the pusher seal assembly may be as described elsewhere herein.

According to a further aspect, there is provided a pre-assembled pusher seal cartridge for a mechanical seal providing a seal around a rotating shaft. The pre-assembled pusher seal cartridge comprises a pusher seal assembly as described herein. The pre-assembled cartridge allows for easy transport and installation of the pusher seal assembly.

Preferably, the pre-assembled pusher seal cartridge comprises a pusher seal housing as described herein, for example a split ring retainer. The pusher seal housing has an axially inboard wall and axially outboard wall, connected by an axially extending wall. Preferably, the pusher seal assembly is contained within the pusher seal housing, for example, the biasing mechanism, the first seal ring and the graphite seal ring (and any other components such as a compression ring or an annular bearing) are axially disposed between the axially inboard wall and axially outboard wall. The loading structure may be operable to compress the graphite seal ring and the first seal ring axially between the axially inboard wall and the axially outboard wall.

The pre-assembled pusher seal cartridge may comprise a loading structure as defined herein, wherein the loading structure is configured to compress the graphite seal ring and the first seal ring axially between the inboard wall and axially outboard wall of the pusher seal housing. In preferred embodiments, the loading structure may comprise an axially fixable collar with threaded holes that allow screws to pass through. The loading structure may operate as described elsewhere herein.

A pre-assembled pusher seal cartridge as described herein may allow for convenient installation of a pusher seal comprising a secondary seal provided by a graphite seal ring. This permits the cartridge to be placed in a mechanical seal around a shaft, and the graphite seal ring compressed to form the secondary seal.

According to a further aspect, there is provided a method for installing a pusher seal assembly in a mechanical seal for providing a seal around a rotating shaft, the method comprising the steps of:
i) arranging a pusher seal annularly about a rotating shaft, the pusher seal comprising an axially movable graphite seal ring to provide a secondary seal against a surface along which a first seal ring of the pusher seal is axially movable;
ii) applying axial pressure to the graphite seal ring to cause radial expansion of the graphite seal ring to form the seal against the surface along which the first seal ring is axially movable.

In preferred embodiments, the pusher seal assembly may be a pusher seal assembly according to the present disclosure. Therefore, the method may involve a step of providing a pusher seal according to the present disclosure or providing a pre-assembled pusher seal cartridge according to the present disclosure.

Step (i) of arranging a pusher seal annularly about a rotating shaft may comprise the step of axially fixing the pusher seal assembly or pre-assembled pusher seal cartridge to the surface along which the first seal ring is axially movable prior to applying axial pressure to the graphite seal ring. For example, the pusher seal assembly may comprise radial screws that attach the pusher seal assembly to either the stationary housing or a rotating shaft, for example via a shaft sleeve. Then axial pressure may be applied to the graphite seal ring to seal the system to either the stationary housing or rotating shaft respectively.

The step (ii) of applying axial pressure to the graphite ring to cause radial expansion of the graphite seal ring to form the seal against the surface along which the first seal ring is axially movable may be performed in any suitable way, for example by operating the loading structure according to embodiments of the pusher seal assembly described herein. The radial expansion of the graphite seal ring is preferably non-elastic expansion. Operation of the loading structure may involve engaging axially movable loading members within an axially fixed collar or sleeve. The axially movable loading members may preferably be screws that can be screwed into the axially fixed collar or sleeve to compress the graphite seal ring.

The loading structure suitably applies axial pressure in order to cause radial expansion of the graphite seal ring. This radial expansion may suitably be non-elastic, such that the graphite seal ring remains in a sealing configuration even if the axial pressure is removed. Accordingly, the method of the present invention preferably further includes the step of removing the axial pressure applied to the graphite seal ring.

According to yet a further aspect, there is provided use of a graphite seal ring as a dynamic secondary seal in a mechanical pusher seal system to improve thermal and/or chemical resistance of the seal. Graphite has good mechanical and chemical properties across a wide range of temperatures and pressures. Additionally, graphite has good compatibility with a wide range of chemicals. The present inventors have surprisingly found that by providing axial pressure to the graphite seal ring, above that usually applied in a mechanical seal, and causing radial expansion of the graphite seal ring after installation within a mechanical seal, a dynamic secondary seal can be achieved using a graphite seal ring.

Aspects of the present disclosure will now be described by way of example and with reference to the figures below.

### BRIEF DESCRIPTION OF THE DRAWINGS

FIG. 1 is a schematic partial cross-sectional view of an embodiment of the pusher seal assembly of the present disclosure.

FIG. 2 is a schematic partial cross-sectional view of an embodiment of the mechanical seal system of the present disclosure.

FIG. 3 is a schematic partial cross-sectional view of an embodiment of a pre-assembled pusher seal cartridge of the present disclosure.

FIG. 4 is a schematic partial cross-sectional view of an embodiment of a pre-assembled pusher seal cartridge of the present disclosure.

FIG. 5 shows a schematic partial cross-sectional view of a portion of the pusher seal assembly of the present disclosure.

FIGS. 6 to 8 show alternative configurations of the pusher seal assembly of the present disclosure.

FIG. 9 shows an expanded view of a pusher seal assembly according to the present disclosure.

### DETAILED DESCRIPTION

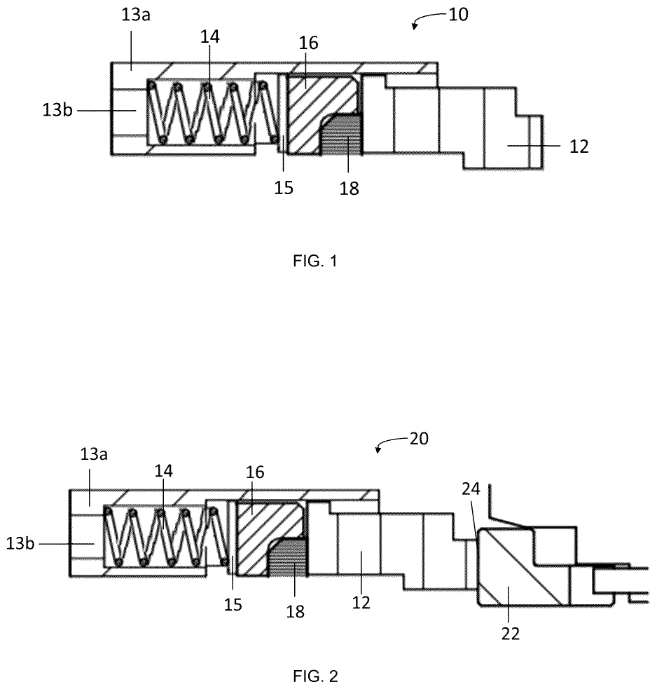

FIG. 1 provides a schematic partial cross-sectional view of a pusher seal assembly according to a preferred embodiment of the present disclosure. Since the assembly is annular, only one-half of the pusher seal assembly has been illustrated for convenience. However, the skilled person can readily envisage that the annular system will extend around the circumference of a shaft around which it is installed.

In FIG. 1, the pusher seal assembly 10 comprises an axially movable first seal ring 12 configured to be disposed annularly about a rotating shaft (not illustrated). The pusher seal comprises a loading structure 13, which is an axially fixed collar 13a with a threaded hole 13b configured to engage with a screw (not illustrated). The axially fixed collar is fixed to the rotating shaft or a shaft sleeve with radially extending screws (not illustrated).

The pusher seal assembly 10 comprises a biasing mechanism which comprises a series of coil springs 14, of which one is illustrated. The coil spring 14 is positioned between an axially-facing wall of the axially fixed collar and an annular thrust washer 15. The thrust washer evenly distributes the force exerted by the coil springs 14 around the circumference of the first seal ring 12. The thrust washer 15 is positioned between the coil springs 14 and a compression ring 16. The compression ring 16 has an annular groove at its inner diameter, adjacent to a surface of the rotating shaft, such as a shaft sleeve coupled to the rotating shaft (though it will be appreciated that where the pusher seal is coupled to the stationary side of the seal, i.e. the stationary housing, rather than the shaft, this surface will be a rotationally stationary surface coupled to the stationary housing). Within the annular groove sits a graphite seal ring 18. The graphite seal ring 18 is positioned between the compression ring 16 and the first seal ring 12. An axially extending surface of the annular groove of the compression ring 16 will direct the expansion of the graphite seal ring 18 radially inwards towards an axially extending surface of the rotating shaft or a surface coupled to the rotating shaft to form a seal against the surface along which the first seal ring 12 and the graphite seal ring 18 move axially.

The system works as a pusher seal assembly within a mechanical seal system 20 where the graphite seal ring 18 provides a dynamic secondary seal to prevent the passage of fluid under the first seal ring 12.

FIG. 2 provides a schematic partial cross-sectional view of a mechanical seal system 20 according to a preferred embodiment of the present disclosure. The pusher seal assembly of FIG. 1 is present with a second seal ring 22. The first seal ring 12 is opposite the second seal ring 22 to form a rotating seal interface 24 therebetween the two seal faces. The second seal ring 22 is attached to the stationary housing that surrounds the rotating shaft (although it will be appreciated that the rotating and stationary sides of the seal may be reversed so that the pusher seal assembly is coupled to the stationary housing and the second seal ring coupled to the rotating shaft).

The flexible graphite ring 18 acts as the secondary seal. In the embodiment illustrated in FIG. 2, the flexible graphite ring 18 seals the mechanical seal assembly 20 to the rotating shaft, however the opposite configuration is also envisaged. The coil springs 14 then act to ensure that the first seal ring 12 moves axially to maintain the seal interface 24 with the second seal ring 22 during operation, for example when shaft movement opens or closes the seal interface 24. For example, during use, the rotating shaft may move slightly axially within the stationary housing. The coil springs 14 bias the first seal ring 12 axially to maintain pressure at the seal interface 24, despite movement of the rotating shaft (for example by compression or elongation of the coil springs 14, depending on the direction of shaft movement).

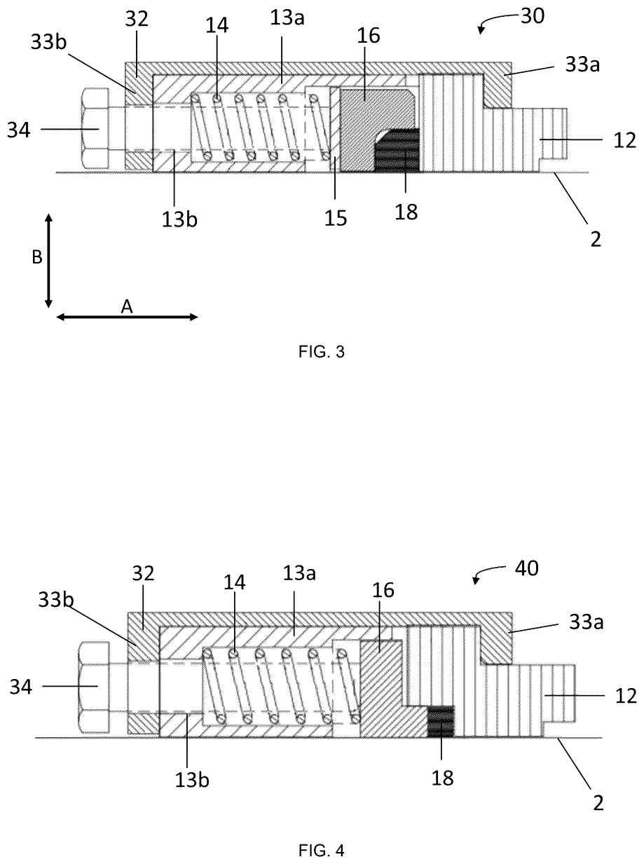

FIG. 3 provides a schematic partial cross-sectional view of a pre-assembled pusher seal cartridge 30 according to a preferred embodiment of the present disclosure. For the avoidance of doubt, FIG. 3 shows schematically the orientation of the axial direction “A” and the radial direction “B” in relation to the mechanical seal, and it will be appreciated that, although not shown in all figures, the “axial” and “radial” directions shown apply to all of FIGS. 1 to 8. Similarly to the system illustrated in relation to FIGS. 1 and 2, the pre-assembled pusher seal cartridge 30 comprises an axially movable first seal ring 12 configured to be disposed annularly about the rotating shaft having an axially extending surface 2 along which the first seal ring 12 and the graphite seal ring 18 move axially. The pre-assembled pusher seal cartridge 30 comprises a biasing mechanism which is a series of coil springs 14, of which one is illustrated. The coil spring 14 is positioned against an annular thrust washer 15. The thrust washer 15 evenly distributes the force exerted by the spring around the circumference of the first seal ring 12. The thrust washer 15 is positioned between the coil springs 14 and a compression ring 16. In FIG. 3, the compression ring 16 has an annular groove at its inner diameter, adjacent to an axially extending surface 2 of the rotating shaft, such as a shaft sleeve coupled to the rotating shaft. It will be appreciated that surface 2 may be a surface of the shaft or a surface of a shaft sleeve fixed to, and which rotates with, the rotating shaft. Within the annular groove, there is a flexible graphite ring 18 that provides a secondary seal against surface 2. Similarly to FIGS. 1 and 2, the pusher seal comprises a loading structure 13, which comprises an axially fixed collar 13a with a threaded hole 13b configured to engage with a screw 34. The axially fixed collar is fixed to the rotating shaft or a shaft sleeve with radially extending screws (not illustrated). Furthermore, the pre-assembled pusher seal cartridge 30 comprises a split ring retainer 32 that surrounds the coil spring 14, thrust washer 15, compression ring 16 and the flexible graphite seal ring 18. The loading structure 13 comprises the axially fixed collar 13a with threaded holes 13b and a series of axially movable screws 34, of which one is illustrated. Additionally, the split ring retainer 32 has a front lip 33a that engages the first seal ring 12 to limit its axial movement away from the graphite seal ring 18. The split ring retainer 32 also has a rear lip 33b that engages the axially fixed collar 13a. The axially movable screws 34 are tightened within the threaded hole 13b to compress the graphite seal ring 18 between the compression ring 16 and the first seal ring 12, the first seal ring being held axially in place by the split ring retainer front lip 33a. The graphite seal ring 18 will then be crushed and deform to form a seal against an axially extending surface 2 the rotating shaft (or a shaft sleeve or other suitable component fixed to the shaft).

The split ring retainer 32 comprises cut outs in the rear lip 33b that align with the threaded holes 13b where each radially extending screw 34 is positioned. This allows for the split ring retainer 32 to be removed without the axially movable screws 34 being removed, and allows the screws 34 to be operated while the split ring retainer 32 is in place.

FIG. 4 provides a schematic partial cross-sectional view of a pre-assembled pusher seal cartridge 40 according to an alternative embodiment of the present disclosure. FIG. 4 illustrates an alternative configuration of the compression ring 16, graphite ring 18 and the first seal ring 12. In this example, the compression ring 16 contains an annular groove at its outer diameter. The first seal ring 12 contains a protrusion, which sits within this annular groove. Between the protrusion of the first seal ring 12 and the inner diameter of the first seal ring 12, there is a gap within which the flexible graphite seal ring 18 is positioned. Alternatively, it can be considered that the first seal ring 12 comprises an annular groove at its inner diameter, within which the graphite seal ring 18 sits. An axially extending protrusion of the compression ring 16 extends into the annular groove to allow axial force applied to the compression ring to compress the graphite seal ring 18 axially against the first seal ring 12. In this example, the compression ring 16 acts to distribute the force exerted by the springs across the back of the first seal ring.

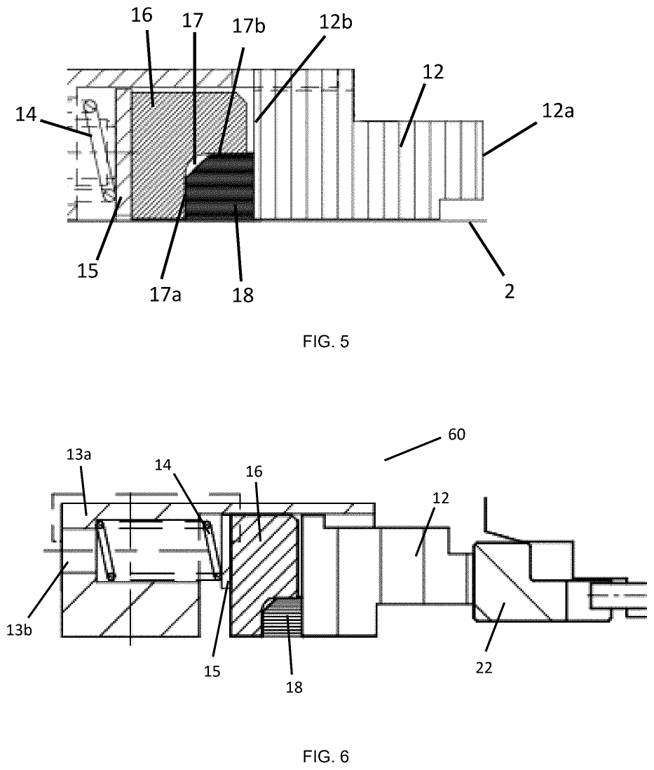

FIG. 5 shows a close-up view of the compression ring 16, graphite seal ring 18 and first seal ring 12 shown in FIG. 3. As described previously, the compression ring 16 comprises an annular groove 17 at its inner diameter, that receives the graphite seal ring 18. The annular groove 17 of the compression ring 16 has an axially extending surface 17b configured to engage the graphite seal ring 18 so that when the graphite seal ring 18 is compressed axially against a rear-facing surface 12b of the first seal ring 12, expansion of the graphite seal ring 18 is directed radially inward towards the surface 2 (i.e. a surface of the shaft or a shaft sleeve along which the first seal ring 12 and graphite seal ring 18 move axially in use). The annular groove 17 also has a radially extending surface 17a configured to engage the graphite seal ring 18 to provide axial pressure against the graphite seal ring 18. As shown, the first seal ring 12 comprises a seal face 12a for forming the seal interface 24 with the second seal ring 22.

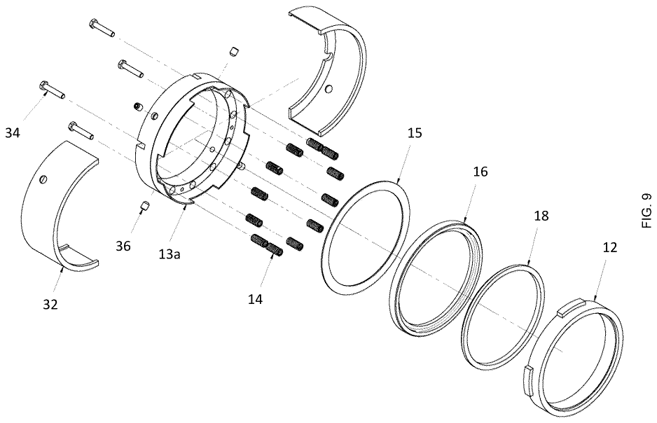

As is shown in the Figures, where the graphite seal ring 18 is arranged in an annular groove of the compression ring 16 or the first seal ring 12, the axial length of the annular groove is smaller than the axial length of the graphite seal ring 18 to allow for compression of the graphite seal ring 18 (FIGS. 1 to 3 and 5 to 7, for example). Alternatively, where the annular groove has an axial length larger than the axial length of the graphite seal ring 18 (FIGS. 4 and 8, for example), a protrusion is provided in the other of the compression ring 16 or the first seal ring 12, in order to compress the graphite seal ring 18 axially within the annular groove.

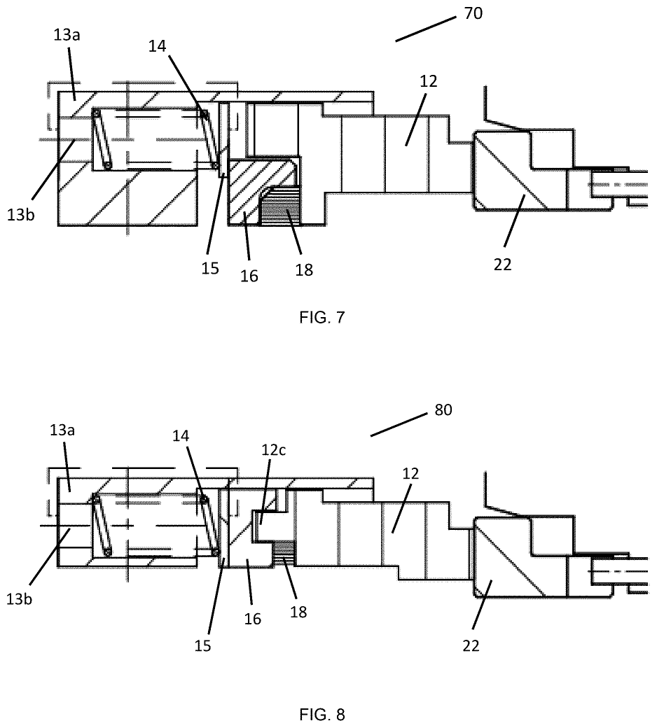

FIGS. 6, 7 and 8 show different configurations of pusher seals 60, 70 and 80 according to the present disclosure. As will be appreciated, the elements of the seal are as described in relation to FIGS. 1 to 5. In FIG. 8, the first seal ring 12 comprises a protrusion 12c that is configured to engage a corresponding groove of the compression ring 16, with the radially inward-facing surface of the protrusion 12c engaging the graphite seal ring 18 and providing a surface that directs radial expansion of the graphite seal ring 18 inwards to form the secondary seal.

FIG. 9 shows an expanded view of a pusher seal assembly according to the present disclosure. As can be seen the components are arranged coaxially. The axially fixed collar 13a comprises set screws 36 for coupling to the shaft. The coil springs 14 are arranged between the axially fixed collar 13a and the thrust washer 15, the compression ring 16 is disposed between the thrust washer 15 and the graphite seal ring 18. The graphite seal ring 18 fits into an annular groove at the inner diameter of the compression ring 16, and is arranged between the compression ring 16 and the first seal ring 12. When these components are combined, the split ring retainer 32 can be added to axially contain the other components. The screws 34 can then be tightened to apply axial pressure, via the thrust washer 15 and the compression ring 16, to the graphite seal ring 18, which can cause inelastic radially inward expansion of the graphite seal ring 18 (directed by the compression ring) to form a secondary seal against a shaft or shaft sleeve at the inner diameter of the graphite seal ring 18.

The pusher seal assembly illustrated in the Figures may be installed by the following exemplified method. A pusher seal cartridge, such as pusher seal cartridge 30 or 40 is arranged annularly about the rotating shaft of the system to be sealed in engagement with surface 2. At this stage, a typical elastomeric seal ring in place of graphite seal ring 18 would have been radially extending beyond the surface 2 prior to installation, so that when the seal is installed, the elastomeric ring is stretched or compressed, where the force provided by the elastic deformation of the elastomeric ring provide a seal against the surface 2 and the first seal ring 12. However, graphite seal rings are not elastomeric and so installation in this manner is not possible.

In the case of the pusher seal assembly according to the present disclosure, the collar 13a may be attached to the rotating shaft, for example by operating radially extending screws (not illustrated) to couple to the rotating shaft. The axially movable screws 34 are then tightened within the threaded hole 13b of the axially fixed collar 13a to press the thrust washer 15, the compression ring 16 and the graphite ring 18 against the back of the first seal ring 12, which is held in position axially by the front lip 33a of the split ring retainer 32. This axial pressure causes the graphite ring 18 to crush and radially expand as it deforms. The radial expansion pushes the graphite seal ring 18 against the surface 2 as well as against the first seal ring 12, to provides a secondary seal against the surface 2. The deformation of the graphite seal ring is inelastic, and so the axial force provided by the screws 34 can be removed whilst maintaining the seal of the graphite seal ring 18 against the surface 2. The axially movable screws 34 are then released and removed from the axially fixed collar 13a and the split ring retainer 32 is removed. The pusher seal can then operate as usual, where, for example due to axial shaft movement, the springs 14 act to slide the first seal ring 12 and the graphite seal ring 18 along surface 2 to maintain a consistent seal interface 24 between the first seal ring 12 and the second seal ring 22.

1. A pusher seal assembly for a mechanical seal providing a seal around a rotating shaft, the pusher seal assembly comprising:
an axially movable first seal ring configured to be disposed annularly about the rotating shaft, the axially movable first seal ring comprising a first seal face for providing a seal interface with a second seal face of a second seal ring;
a biasing mechanism configured to provide an axial biasing force on the axially movable first seal ring orthogonal to the first seal face;
a secondary seal configured to provide a seal against a surface along which the axially movable first seal ring is axially movable, wherein the secondary seal comprises a graphite seal ring; and
the pusher seal assembly is configured to allow axial pressure to be applied to the graphite seal ring separately from the biasing mechanism to cause radial expansion of the graphite seal ring.

2. The pusher seal assembly according to claim 1, further comprising a loading structure for applying axial pressure to the graphite seal ring separately from the biasing mechanism.

3. The pusher seal assembly according to claim 2, wherein the loading structure is operable to apply adjustable axial pressure to the graphite seal ring.

4. The pusher seal assembly according to claim 2, wherein the loading structure comprises an axially fixed collar or sleeve configured to engage one or more axially movable loading members.

5. The pusher seal assembly according to claim 4, wherein the one or more axially movable loading members comprise one or more screws.

6. The pusher seal assembly according to claim 1, wherein the axial pressure on the graphite seal ring is at least in part provided by the biasing mechanism.

7. The pusher seal assembly according to claim 6, wherein the graphite seal ring is arranged between the biasing mechanism and the axially movable first seal ring.

8. The pusher seal assembly according to claim 1, wherein the secondary seal further comprises a compression ring arranged to engage the graphite seal ring.

9. The pusher seal assembly according to claim 8, wherein the compression ring and/or the axially movable first seal ring comprises an annular groove and the graphite seal ring is arranged within the annular groove.

10. The pusher seal assembly according to claim 9, wherein the graphite seal ring protrudes axially from the annular groove to allow compression of the graphite seal ring.

11. The pusher seal assembly according to claim 8, wherein the graphite seal ring is arranged between the compression ring and the axially movable first seal ring.

12. The pusher seal assembly according to claim 8, wherein the compression ring is formed from a material selected from silicon carbide, stainless steel alloys, nickel alloys or combinations thereof.

13. The pusher seal assembly according to claim 1, wherein the pusher seal assembly further comprises an annular bearing, such as a thrust washer, arranged to circumferentially distribute axial forces applied to the axially movable first seal ring.

14. The pusher seal assembly according to claim 13, wherein the graphite seal ring is arranged between the annular bearing and the axially movable first seal ring.

15. The pusher seal assembly according to claim 1, wherein the secondary seal is substantially PFAS free.

16. The pusher seal assembly according to claim 1, wherein the graphite seal ring is formed from a flexible graphite ribbon material, for example wherein the graphite seal ring comprises a die formed flexible graphite ring.

17. The pusher seal assembly according to claim 1, wherein the pusher seal assembly comprises a pusher seal housing, for example a split ring retainer, the pusher seal housing having an axially inboard wall and an axially outboard wall, for example wherein the biasing mechanism and the axially movable first seal ring are axially disposed between the axially inboard wall and the axially outboard wall.

18. The pusher seal assembly of claim 17, further comprising a loading structure for applying axial pressure to the graphite seal ring separately from the biasing mechanism, wherein the loading structure is operable to compress the graphite seal ring and the axially movable first seal ring axially between the axially inboard wall and the axially outboard wall.

19. A mechanical seal system for providing a seal around a rotating shaft comprising:
a pusher seal assembly according to claim 1 and a second seal ring comprising a second seal face configured to oppose the first seal face to provide a seal interface therebetween;
the biasing mechanism configured to provide an axial biasing force on the axially movable first seal ring towards the second seal ring.

20. A method for installing a pusher seal assembly in a mechanical seal for providing a seal around a rotating shaft, comprising the steps:
i) arranging a pusher seal annularly about a rotating shaft, the pusher seal comprising an axially movable graphite seal ring to provide a secondary seal against a surface along which a first seal ring of the pusher seal is axially movable; and
ii) applying axial pressure to the axially movable graphite seal ring to cause radial expansion of the axially movable graphite seal ring to form the seal against the surface along which the first seal ring is axially movable.
